(19) United States
(12) Patent Application Publication
(10) Pub. No.: US 2008/0292908 A1
(43) Pub. Date: Nov. 27, 2008

(54) PERPENDICULAR MAGNETIC RECORDING MEDIUM, METHOD OF MANUFACTURING PERPENDICULAR MAGNETIC RECORDING MEDIUM, AND MAGNETIC RECORDING APPARATUS

(75) Inventor: Ryoichi Mukai, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/124,734

(22) Filed: May 21, 2008

(30) Foreign Application Priority Data
May 24, 2007 (JP) 2007-138010
Oct. 15, 2007 (JP) 2007-267654

(51) Int. Cl. G11B 5/66; G11B 5/84

(52) U.S. Cl. 428/831; 427/132

(57) ABSTRACT

A perpendicular magnetic recording medium having a substrate, a soft magnetic buffer layer formed on the substrate, an Ru/Ru alloy underlayer formed on the soft magnetic buffer layer, the Ru/Ru alloy underlayer including Ru or a Ru alloy, a recording layer formed on the Ru/Ru alloy underlayer, the recording layer including at least a layer including a plurality of magnetic particles having an easy axis oriented perpendicular to the substrate, and a non-magnetic material surrounding the plural magnetic particles, and a layered structure interposed between the soft magnetic buffer layer and the Ru/Ru alloy underlayer, the layered structure including at least an Ru/Ru alloy crystalline structure film including Ru or a Ru alloy, a first polycrystalline film including Ru or a Ru alloy, and a second polycrystalline film.

### BACKGROUND OF THE INVENTION

1. Field of the Invention

The present invention generally relates to a perpendicular magnetic recording medium, a method of manufacturing a perpendicular magnetic recording medium, and a magnetic recording apparatus, and more particularly, a perpendicular magnetic recording medium, a method of manufacturing a perpendicular magnetic recording medium, and a magnetic recording apparatus for reducing variance of particle diameter and variance of orientation of the crystals of the perpendicular magnetic recording medium.

2. Description of the Related Art

In recent years and continuing, hard disk apparatuses are widely used in, for example, personal computers owing to its inexpensive memory (cost efficiency in terms of memory per single bit) and its ability to store large amounts of data. Furthermore, due to the arrival of the ubiquitous age, the demand for hard disk apparatuses is expected to drastically increase, for example, in the field of digital audio visual equipment. Therefore, hard disk apparatuses are required to record (store) greater amounts of data for recording video signals.

Along with increasing the recording (storage) capacity of hard disk apparatuses, there is also a need to reduce the unit cost of a memory since hard disk apparatuses are to be used for common household products. One method of reducing the unit cost of a memory is to reduce the number of components of the hard disk apparatus. More specifically, by increasing the recording density of a magnetic recording medium (magnetic disk), recording capacity can be increased without increasing the number of magnetic recording media. Furthermore, if a drastic increase of recording density can be realized by increasing recording capacity without increasing the number of magnetic recording media, the number of magnetic heads can be reduced. As a result, the unit cost of a memory can be drastically reduced.

In order to achieve the objective of increasing the recording density of the magnetic recording medium, there is a need to attain a higher SN (signal-to-noise) ratio by increasing resolution (attaining higher output) and reducing noise. As an attempt to achieve this objective, there is a method of realizing finer magnetic grains that constitute a magnetic recording layer, forming the magnetic grains with a uniform size, and magnetically isolating the magnetic grains.

In manufacturing a perpendicular magnetic recording medium according to a related art example, a magnetic recording layer is fabricated by forming a CoCr based alloy film by heating a substrate along with performing a sputtering method. In the CoCr based alloy film, non-magnetic Cr grains are segregated in the crystalline interface (grain boundary) of the CoCr based alloy magnetic grains, to thereby magnetically isolate the magnetic grains. However, the perpendicular magnetic recording medium requires an amorphous soft magnetic layer to be positioned at its bottom layer for preventing generation spike noise due to the forming of a magnetic domain. In order to maintain the amorphous state of the soft magnetic layer, the process of heating the substrate for segregating the Cr grains could not be performed when fabricating the CoCr based alloy film.

As an alternative for the method of segregating Cr grains by using a heating process, there is a method of manufacturing a perpendicular magnetic recording medium where a magnetic recording layer is fabricated with a magnetic film having SiO₂ added to a CoCr alloy. In this magnetic film, CoCr based alloy magnetic crystalline grains are spatially separated from each other by non-magnetic SiO₂, to thereby establish magnetic isolation.

In order to fabricate a magnetic recording layer having a granular structure where magnetic grains are surrounded by a non-magnetic material (e.g., SiO₂), a thick ruthenium (Ru) film is disposed immediately below the magnetic recording layer in a form of continuous film. By forming the crystalline grain portion of the thick Ru film with grooves having suitable depth, a magnetic recording layer having magnetic crystalline grains spatially separated by SiO₂ can be fabricated.

However, in a case where the Ru underlayer inserted between the magnetic recording layer and its underlayer is too thick, the magnetic force (write head magnetic force) required for performing a writing process increases to a level where writing blur occurs. In addition, the increase in the thickness of the Ru underlayer leads to an increase of grain size.

In order to solve this problem, there is a method of forming a Ru underlayer (underlayer of a magnetic recording layer 16) with a gapped structure having Ru crystalline grains 15a spatially separated by gap parts 15b as shown in FIG. 1 (see, for example, Japanese Laid-Open Patent Application No. 2005-353256). In the exemplary configuration shown in FIG. 1, a soft magnetic buffer layer 12 and an orientation control layer 13 are formed on a substrate 11. A recording layer 16 is formed on the orientation control layer 13 via a continuous layer including a first underlayer 14 and the Ru underlayer (second underlayer) having the gapped structure. The recording layer 16 is protected by a cap layer 17. By forming the second underlayer 15 with the gapped structure, the total thickness of the first and second underlayers 14, 15 can be reduced while the grains continue to maintain a uniform grain size in the recording layer 16 formed above the second underlayer 15.

Although a magnetic recording layer can be provided with a granular structure while reducing the total thickness of the first and second Ru underlayers 14, 15 by forming the Ru underlayer 15 with the gapped structure, this configuration cannot achieve both reduction of the write core width (WCW) and obtainment of a high S/N ratio required for attaining high recording density.

### SUMMARY OF THE INVENTION

The present invention may provide a perpendicular magnetic recording medium, a magnetic recording apparatus, and a method of manufacturing a perpendicular magnetic recording medium that substantially obviates one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a perpendicular magnetic recording medium, a magnetic recording apparatus, and a method of manufacturing a perpendicular magnetic recording medium particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides a perpendicular magnetic recording medium having a substrate, a soft magnetic buffer layer formed on the substrate, an Ru/Ru alloy underlayer formed on the soft magnetic buffer layer, the Ru/Ru alloy underlayer including Ru or a Ru alloy, a recording layer formed on the Ru/Ru alloy underlayer, the recording layer including at least a layer including plural magnetic particles having an easy axis oriented perpendicular to the substrate, and a non-magnetic material surrounding the plural magnetic particles and a layered structure interposed between the soft magnetic buffer layer and the Ru/Ru alloy underlayer, the layered structure including at least an Ru/Ru alloy crystalline structure film including Ru or a Ru alloy, a first polycrystalline film including Ru or a Ru alloy, and a second polycrystalline film.

Furthermore, another embodiment of the present invention provides a perpendicular magnetic recording medium having a substrate, a soft magnetic buffer layer formed on the substrate, an Ru/Ru alloy underlayer formed on the soft magnetic buffer layer, the Ru/Ru alloy underlayer including Ru or a Ru alloy, a recording layer formed on the Ru/Ru alloy underlayer, the recording layer including at least a layer including plural magnetic particles having an easy axis oriented perpendicular to the substrate, and a non-magnetic material surrounding the plural magnetic particles, and a layered structure interposed between the soft magnetic buffer layer and the Ru/Ru alloy underlayer, the layered structure including at least a first Ru/Ru alloy crystalline structure film including Ru or a Ru alloy, a NiAl based polycrystalline film positioned directly above the first Ru/Ru alloy crystalline structure film, and a second Ru/Ru alloy crystalline structure film including Ru or a Ru alloy.

Furthermore, another embodiment of the present invention provides a method of manufacturing a perpendicular magnetic recording medium having the steps of a) forming a layered structure including at least an Ru/Ru alloy crystalline structure film including Ru or a Ru alloy on a substrate, a first polycrystalline film including Ru or a Ru alloy, and a second polycrystalline film, b) forming an Ru/Ru alloy underlayer formed on the layered structure, the Ru/Ru alloy underlayer including crystal grains of Ru or Ru alloy that are spatially separated from each other by gap parts formed in the Ru/Ru alloy underlayer, and c) forming a recording layer on the Ru/Ru alloy underlayer, the recording layer including at least a layer including plural magnetic particles having an easy axis oriented perpendicular to the substrate and a non-magnetic material surrounding the plural magnetic particles.

Furthermore, another embodiment of the present invention provides a method of manufacturing a perpendicular magnetic recording medium having the steps of a) forming a layered structure including at least a first Ru/Ru alloy crystalline structure film including Ru or a Ru alloy, a NiAl based polycrystalline film positioned directly above the first Ru/Ru alloy crystalline structure film, and a second Ru/Ru alloy crystalline structure film including Ru or a Ru alloy, b) forming an Ru/Ru alloy underlayer formed on the layered structure, the Ru/Ru alloy underlayer including crystal grains of Ru or Ru alloy that are spatially separated from each other by gap parts formed in the Ru/Ru alloy underlayer, and c) forming a recording layer on the Ru/Ru alloy underlayer, the recording layer including at least a layer including plural magnetic particles having an easy axis oriented perpendicular to the substrate and a non-magnetic material surrounding the plural magnetic particles.

Other objects and further features of the present invention will be apparent from the following detailed description when read in conjunction with the accompanying drawings.

### BRIEF DESCRIPTION OF THE DRAWINGS

FIG. 1 is schematic view showing a perpendicular magnetic recording medium according to a related art example;

FIG. 2 is a cross-sectional view showing a perpendicular magnetic recording medium according to a first embodiment of the present invention;

FIG. 3 is a schematic diagram showing a portion of the configuration of FIG. 2 in detail;

FIG. 4 is a schematic diagram for describing growth of a crystalline structure formed of Ru or Ru alloy to be used for the perpendicular magnetic recording medium of FIG. 2;

FIGS. 5A and 5B are schematic diagrams for describing effects attained when a NiAl polycrystalline film is provided by showing XRD rocking curves when no NiAl polycrystalline film is provided in a case where the material of a crystalline structure is changed and in a case where no crystalline structure is provided;

FIGS. 6A and 6B are schematic diagrams for describing effects attained when a NiAl polycrystalline film is provided by showing XRD rocking curves when a NiAl polycrystalline film is provided in a case where the material of a crystalline structure is changed and in a case where no crystalline structure is provided;

FIGS. 7A and 7B are schematic diagrams for describing effects attained when a NiAl polycrystalline film is provided by showing XRD rocking curves when no NiAl polycrystalline film is not provided in a case where the thickness of a Ru underlayer is changed;

FIGS. 8A and 8B are schematic diagrams for describing effects attained when a NiAl polycrystalline film is provided by showing XRD rocking curves when no NiAl polycrystalline film is provided in a case where the thickness of a Ru underlayer is changed;

FIG. 9 is a graph showing dependency of signal to noise ratio (S/Nt) of various samples with respect to write core width (WCW);

FIG. 10 is a schematic diagram showing a perpendicular magnetic recording medium according to a second embodiment of the present invention;

FIG. 11 is a schematic diagram showing a perpendicular magnetic recording medium according to a third embodiment of the present invention;

FIG. 12 is a schematic diagram showing a perpendicular magnetic recording medium according to a fourth embodiment of the present invention;

FIG. 13 is a schematic diagram showing a perpendicular magnetic recording medium according to a fifth embodiment of the present invention;

FIG. 14 is a schematic diagram showing a perpendicular magnetic recording medium according to a sixth embodiment of the present invention;

FIG. 15 is a table for describing variance of crystal orientation of the perpendicular magnetic recording media according to the first-sixth embodiments of the present invention;

FIG. 16 is a graph for describing a relationship between coercivity and the thickness of a magnetic recording medium having a granular structure;

FIG. 17 is a graph for describing a relationship between signal to noise ratio and the thickness of a magnetic recording medium having a granular structure;

FIG. 18 is a graph for describing a relationship between overwrite characteristics and the thickness of a magnetic recording medium having a granular structure; and

FIG. 19 is a schematic diagram showing a magnetic recording apparatus to which a perpendicular magnetic recording medium according to an embodiment of the present invention is applied.

### DESCRIPTION OF THE PREFERRED EMBODIMENTS

In the following, embodiments of the present invention will be described with reference to the accompanying drawings.

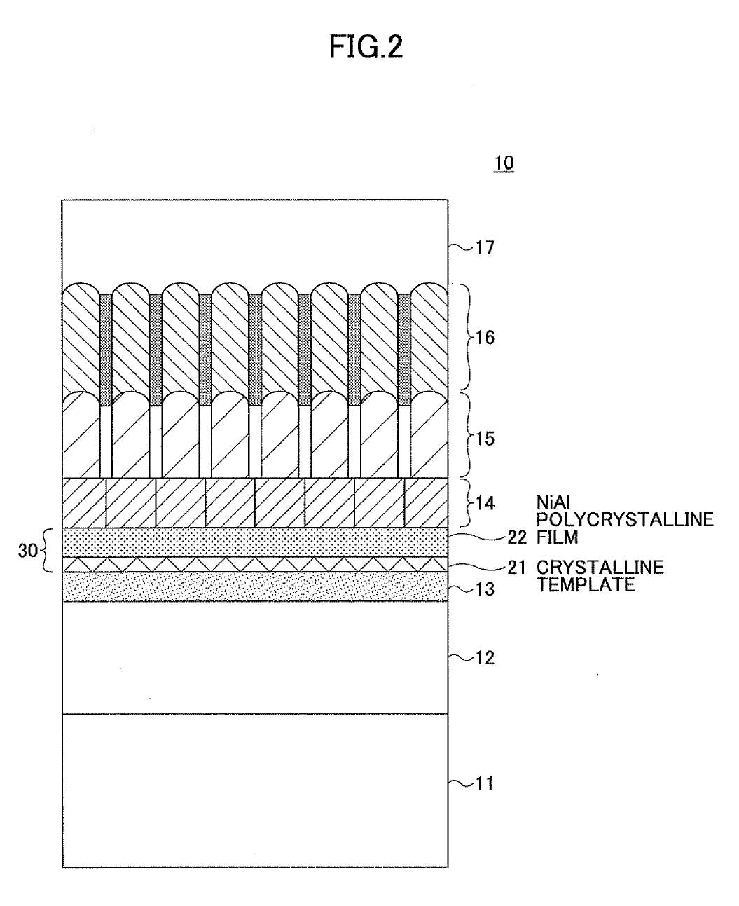

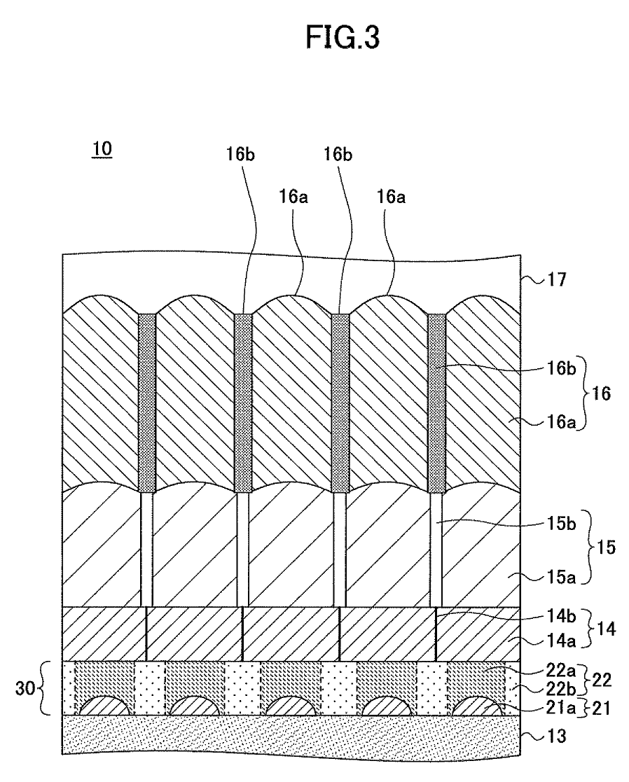

FIG. 2 is a cross-sectional view showing a perpendicular magnetic recording medium according to a first embodiment of the present invention. FIG. 3 is a schematic diagram showing a portion of the configuration of FIG. 2 in detail. The perpendicular magnetic recording medium 10 has a soft magnetic buffer layer 12, an orientation control layer 13, a crystalline structure template 21, a polycrystalline film 22, a first underlayer 14, a second underlayer 15, a recording layer 16, and a cap layer 17 formed on a substrate 11 in this order. The crystalline structure template 21 is a film having a crystalline structure of Ru or Ru alloy grains that are randomly formed and uniformly arranged therein. For the sake of convenience, this film also may be referred to as a template. The crystalline structure template 21 and the polycrystalline film 22 that are interposed between the soft magnetic buffer layer 12 and the underlayer (first or second underlayer) form a layered structure 30.

The substrate 11 may be a given substrate suitable for use as a substrate of a magnetic recording medium. For example, the substrate 11 may be a plastic substrate, a glass substrate, a Si substrate, a ceramic substrate, or a heat-resistant resin substrate. A glass disk substrate is used as the substrate 11 in the first embodiment of the present invention.

The soft magnetic buffer layer (also referred to as SUL (Soft magnetic Under Layer)) 12 is formed of a given amorphous or micro-crystallite. The soft magnetic buffer layer 12 has a thickness of approximately 50 nm to 2 μm. The soft magnetic buffer layer 12 may be formed as a single layer or plural layers. The soft magnetic buffer layer 12 is for absorbing magnetic flux from a recording head. Thus, the product of saturation flux density Bs and the thickness of the soft magnetic buffer layer 12 is preferred to be large. A a soft magnetic material having a saturation flux density no less than 1.0 T is preferred. For example, there is, for example, FeSi, FeAlSi, FeTaC, CoZrNb, CoCrNb, NiFeNb, and Co.

The orientation control layer 13 has a thickness of approximately 1.0 nm to 10 nm. The orientation control layer 13 directs the c axis of the crystal grains of the first and second underlayers 14, 15 in the thickness direction. In addition, the orientation control layer 13 also uniformly distributes the crystal grains of the first and second underlayers 14, 15 in the in-plane direction of the substrate. The orientation control layer 13 may include at least one of the following amorphous materials: Ta, Ti, C, Mo, W, Re, Os, Hf, Mg, Pt, or an alloy of these materials. In view of the necessity of positioning the soft magnetic buffer layer 12 and the recording layer 16 close to each other and satisfactorily controlling the orientation of the crystal grains of the layers positioned above the orientation control layer 13, the orientation control layer 13 is preferred to have a thickness ranging from 2.0 nm through 5.0 nm.

The Ru or Ru alloy crystalline structure included in the crystalline structure template 21 serves to restrain (control) the variance of grain size of the crystal grains included in the layers positioned above the crystalline structure template 21. Meanwhile, the polycrystalline film 22 formed on the crystalline structure template 21 serves to restrain (control) the variance of the crystal orientation of the layers positioned above the polycrystalline film 22. In view of the necessity of reducing the distance between the recording layer 16 and the soft magnetic buffer layer 12 and ensuring crystallinity of its crystalline material, the polycrystalline film 22 is formed with a thickness ranging from 2 nm through 4 nm. A NiAl polycrystalline film having a thickness of 3 nm is used in the first embodiment of the present invention. By combining the Ni Al poly crystalline film with the Ru or Ru alloy crystalline structure, the variance of grain size and the variance of crystal orientation of the crystal grains included in the layers positioned above the combined configuration (Ni Al poly crystalline film and the Ru or Ru alloy crystalline structure) can be effectively restrained (controlled).

FIG. 3 is a diagram showing a portion of the perpendicular magnetic recording medium 10 shown in FIG. 2. The crystalline structure template 21 includes crystalline structures 21a formed of Ru or Ru alloy (hereinafter also referred to as “Ru/Ru alloy crystalline structure” for the sake of convenience). The crystalline structures 21a have Ru or Ru alloy grains randomly formed and uniformly arranged on the orientation control layer 13. The crystalline structures 21a have a smaller grain size than that of the grains in the first underlayer 14 and are formed with high density. The height of the crystalline structure 21a ranges from 1 nm through 2 nm (more preferably, 1.5 nm). For example, the crystalline structure 21a may be fabricated with a DC sputtering deposition performed by sputtering a Ru or Ru alloy target on an amorphous Ta film (serving as the orientation control film 13) with a high argon (Ar) gas pressure of 7 Pa to 8.5 Pa. The deposition is performed at an extremely small deposition rate, for example, a deposition rate which is no greater than 0.5 nm/sec. In a case of fabricating the crystalline structure 21a having a height of approximately 1.5 nm, the grain size of the crystalline structure 21a is no greater than 2 nm.

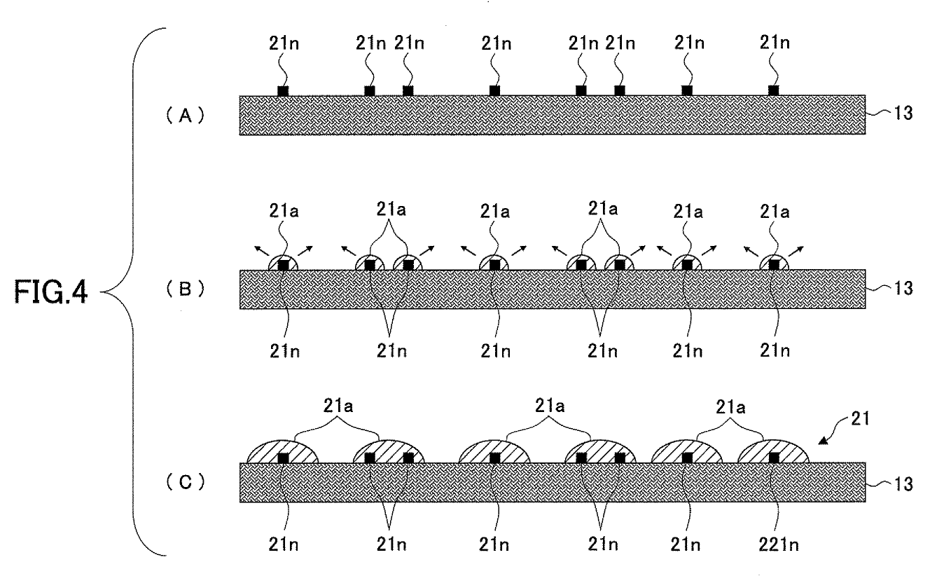

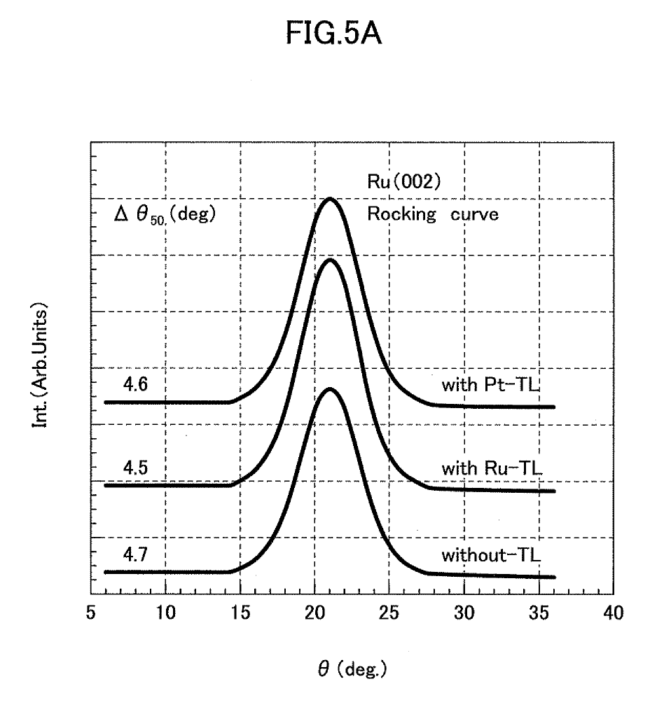

FIG. 4 is a schematic diagram exemplarily showing the steps of the growth of the crystalline structure 21a according to an embodiment of the present invention. In the example shown in FIG. 4, the crystalline structure 21a is a Ru crystalline structure. First, as shown in FIG. 4A, the nuclei 21n of Ru are uniformly formed at random areas on the Ta orientation control film 13. Then, as shown in FIG. 4B, the Ru nuclei grow into Ru crystal grains 21a. At the stages where the Ru grains 21a have small grain size, the Ru crystal grains 21a combine with each other. Eventually, the combined Ru crystal grains 21a become crystalline structures having substantially same grain sizes and being disposed uniformly at random areas on the orientation control film 13. As described above, this arrangement of the crystalline structures 21a is referred to as a template 21. With the Ru (Ru alloy) crystalline structure 21a, the variance of grain size of the crystal grains of the layers formed above the crystalline template 21 can be effectively restrained (controlled).

In the NiAl film 22 that cover the Ru/Ru alloy crystalline structure 21a, although the NiAl material directly deposited on the amorphous Ta film 13 becomes an amorphous material 22b, the NiAl material deposited on the crystalline structure 21a becomes a crystalline material 22a. Thus, the crystalline material 22a becomes dominant (main area) in the NiAl film 22. In this sense, the NiAl film 22 is also referred to as a polycrystalline film 22. The NiAl film 22, affected by the configuration of the Ru/Ru alloy crystalline structures 21a, enables the uniform grain size of the crystalline grains of the crystalline structure 21a to be inherited by the layers positioned above the NiAl film 22. Furthermore, since the main area of the NiAl film 22 is formed of a crystalline material, the crystal orientation of the crystal grains of the Ru underlayer 14 formed on the NiAl film 22 can be improved.

In a case where the crystalline structure 21 is formed of Ru alloy grains, the Ru alloy grains are represented as “Ru—X” having Ru as its main component. For example, “X” of Ru—X according to this embodiment of the present invention includes at least one of Co, Cr, Fe, Ni, W, or Mn.

As an alternative of the NiAl polycrystalline film 22, the polycrystalline film 22 may be an alloy material formed by adding a single element material to an NiAl alloy. In this case, the single element includes at least one of B, Pt, W, Ag, Au, Pd, Nb, Ta, Cr, Si, or Ge.

Returning to FIG. 3, the first underlayer 14 provided on the polycrystalline film 22 is formed as a continuous polycrystalline film including Ru or a Ru alloy having a hcp (hexagonal close packed) structure. The first underlayer 14 according to this embodiment of the present invention includes crystal grains 14a and crystal grain boundaries 14. Since the first underlayer 14 has a continuous polycrystalline configuration where crystal grains 14a are combined via the crystal grain boundaries 14b, a satisfactory crystallinity can be attained in the first underlayer 14 where the crystal orientation of the (001) plane is perpendicular with respect to the substrate 11. Although the perpendicular magnetic recording medium 10 may be fabricated without the first underlayer 14, it is preferred to have the first underlayer 14 situated immediately below the second underlayer 15 from the aspect of improving crystallinity and orientation of the second underlayer 15 and the recording layer 16 positioned above the first underlayer 14.

The second underlayer 15 is positioned above the first underlayer 14. The second underlayer 15 includes crystal grains 15a oriented in a direction perpendicular to the substrate 11 and gap parts 15b that separate the crystal grains 15a in an in-plane direction.

The recording layer 16 is positioned on the second underlayer 15. The recording layer 16 has a thickness ranging from, for example, 6 nm through 20 nm. The recording layer 16 includes magnetic crystal grains 16a formed as columns extending in a direction perpendicular to the substrate 11, and non-magnetic materials 16b separating the magnetic crystal grains 16a in an in-plane direction. The magnetic crystal grains 16a according to this embodiment of the present invention are formed of a ferromagnetic material having an hcp crystal structure. It is preferable to use a Co based alloy such as CoCr, CoCrTa, CoPt, CoCrPt, or CoCrPt-M. The non-magnetic material 16b may be a given non-magnetic material that neither exhibits solubility nor forms a compound with respect to the magnetic crystal grains 16a. The non-magnetic material 16b may be, for example, an oxide material (e.g., SiO₂, Al₂O₃, Ta₂O₅), a nitride material (e.g., Si₃N₄, AlN, TaN), or a carbide material (e.g., SiC, TaC). Although FIG. 3 shows the recoding layer 16 formed as a single layer having a configuration including the magnetic crystal grains 16a and the non-magnetic materials 16b surrounding the magnetic crystal grains 16a, the recording layer 16 may be formed as plural layers that include plural layers having this configuration.

The cap layer 17 according to this embodiment of the present invention is a CoCrPt magnetic film. A protective layer (not shown) or a lubricant layer may be provided above the cap layer 17 according to necessity.

In the following, an exemplary method of manufacturing the above-described perpendicular magnetic recording medium 10 is described. First, the surface of the substrate 11 is cleaned and dried. Then, a CoZrNb film having a thickness of 200 nm is formed as the soft magnetic buffer layer 12 on the substrate 11. Then, a Ta film (single layer) having a thickness of 3 nm is formed as the orientation control layer 13 on the CoZrNb film 12. Both the CoZrNb film 12 and the Ta film 13 are formed (deposited) under the same conditions in which a DC sputtering method is performed at room temperature by using Ar gas with a pressure of 0.5 Pa.

Then, a Ru/Ru alloy crystalline structure 21a having a thickness of 1.5 nm are formed on the Ta film (orientation control layer) 13 by performing DC sputtering deposition by using Ar gas with a pressure of 8 Pa. In this example, the deposition rate is 0.5 nm/sec.

Then, a NiAL polycrystalline film 22 having a thickness of 3 nm is formed on the Ru/Ru alloy crystalline structure 21a by performing DC sputtering deposition by using Ar gas with a pressure of 0.5 Pa. In this example, the deposition rate is 2.5 nm/sec. The NiAl polycrystalline film 22 is configured as a continuous film.

Then, a Ru first underlayer 14 having a thickness of 7.5 nm is formed on the polycrystalline film 22 by performing DC sputtering deposition by using Ar gas with a pressure of 7.5 nm. Then, a RU second underlayer 14 having a thickness of 10 nm is formed on the first underlayer 14 by performing DC sputtering deposition by using Ar gas with a pressure of 10 nm. By controlling the deposition rate under a high gas pressure, a gap structure can be formed in the second underlayer 15. Accordingly, the Ru second underlayer 15 attains a uniform grain size corresponding to the uniform grain size of the crystal grains of the crystalline structure 21. Furthermore, the Ru second underlayer 15 attains a crystal orientation corresponding to the orientation of the crystal grains of the NiAl polycrystalline film 22 via the first underlayer 14.

Then, a CoCrPt—SiO₂ film having a thickness of 10 nm is formed as the recording layer 16 on the second underlayer 15 by performing RF or DC sputtering deposition by using Ar gas with a pressure of 4 Pa. More specifically, the CoCrPt crystal grains 16a having an easy axis (easy axis of magnetization) oriented perpendicular to the substrate 11 and SiO₂ materials 16b surrounding the CoCrPt crystal grains 16a are formed at a deposition rate of 0.5 nm/sec.

Finally, a CoCrPt magnetic cap layer 17 having a thickness of 5 nm is formed as the recording layer 16 by performing DC sputtering deposition by using Ar gas with a pressure of 0.5 Pa. In this example, the deposition rate is 0.5 nm/sec. A vacuum atmosphere is maintained throughout the entire processes (steps) performed in the above-described method for manufacturing the perpendicular recording medium 10.

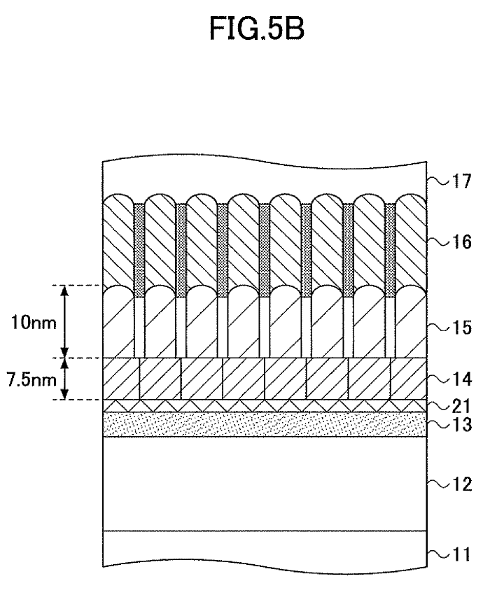

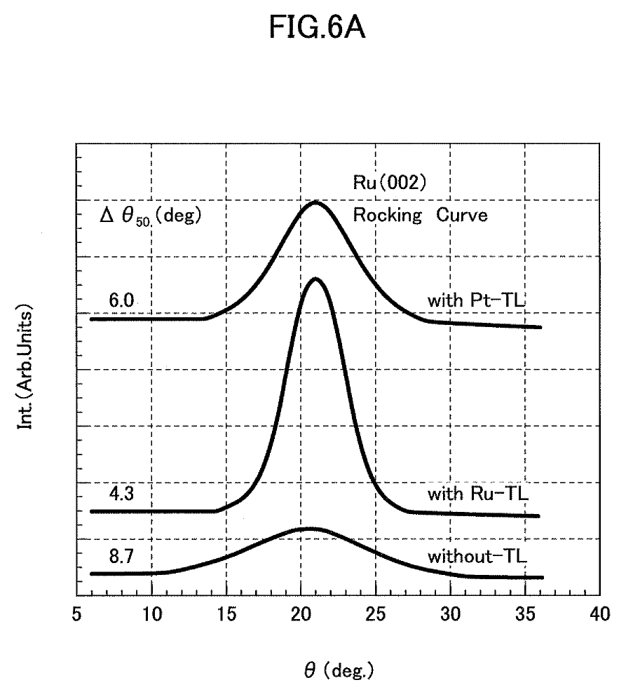

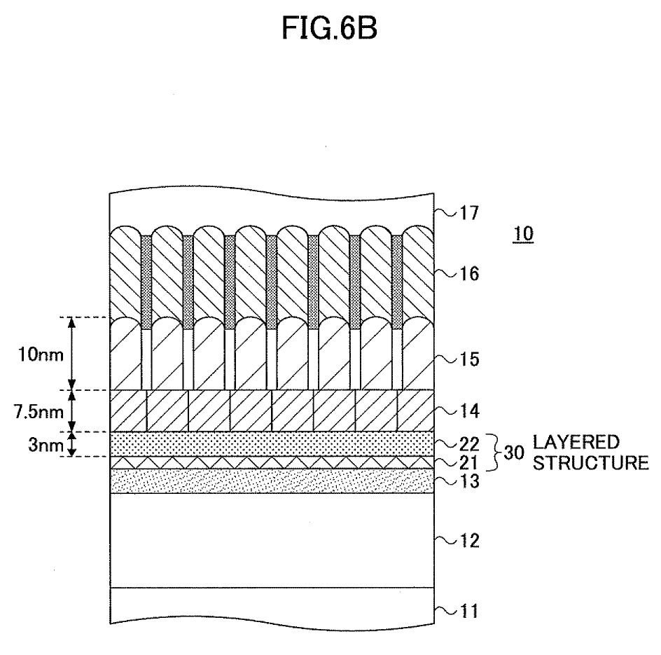

FIGS. 5A through 8B are diagrams for describing the effects obtained by using the combination of the Ru/Ru alloy crystalline structure 21a and the NiAl polycrystalline film 22. FIG. 5A shows XRD rocking curves of a Ru (002) plane when no NiAl polycrystalline film 22 is provided in a case where the material of the crystalline structure 21a is changed and in a case where no crystalline structure 21a is provided. FIG. 6A shows XRD rocking curves of a Ru (002) plane when the NiAl polycrystalline film 22 is provided in a case where the material of the crystalline structure 21a is changed and in a case where no crystalline structure is provided.

Prior to measuring the XRD rocking curves of FIGS. 5A and 6A, samples of the perpendicular recording medium (see FIGS. 5B and 5B) are fabricated by performing the same processes (steps) as those of the above-described method for manufacturing the perpendicular recording medium 10. In measuring the XRD rocking curves of FIGS. 5A and 6A, three types samples are fabricated in which the first sample has the crystalline structure 21a formed with Pt (indicated as “with Pt-TL” in FIGS. 5A and 6A), the second sample has the crystalline structure 21a formed with Ru (indicated as “with Ru-TL” in FIGS. 5A and 6A), and the third sample has the crystalline structure 21a omitted (indicated as “without TL” in FIGS. 5A and 6A). Since no NiAl polycrystalline film 22 is formed in the case of FIG. 5A, the Ru first underlayer 14 and the Ru second underlayer 15 are directly deposited on the crystalline structure 21a. In the case of FIG. 6A, the first and second underlayers 14, 15 are deposited on the NiAL polycrystalline film 22 having a thickness of 3 nm.

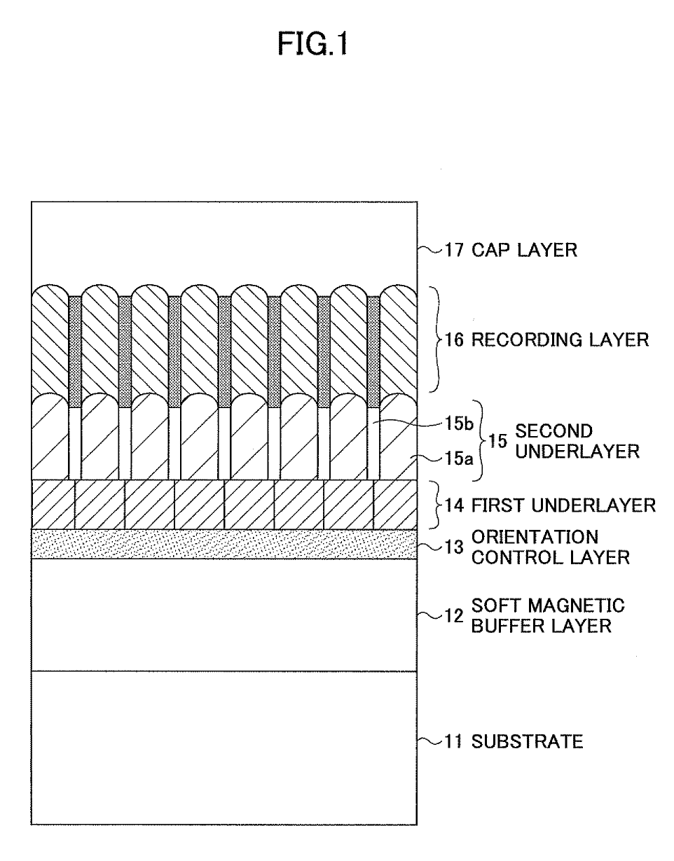

In FIG. 5A, in a case where only the Ru crystalline structure 21a is interposed between the underlayers 14, 15 and the soft magnetic buffer layer 12, the full width at half maximum (hereinafter also referred to as “FWHM”) (Δθ₅₀) of the XRD rocking curve is 4.5°. In a case where only the Pt crystalline structure is interposed between the underlayers 14, 15 and the soft magnetic buffer layer 12, the FWHM of the XRD rocking curve is 4.6°. In a case where the crystalline structure is omitted (i.e. configuration of the related art example shown in FIG. 1), the FWHM of the XRD rocking curve is 4.7°. The FWHM (Δθ₅₀) is an index indicating the variance of the orientation of crystal grains. The orientation of crystal grains becomes better as the value of the FWHM becomes smaller. FIG. 5A shows that, when the NiAl polycrystalline film 22 is not provided, there is little difference between a case where no crystalline structure is interposed, a case where the crystalline structure is formed with Ru, and a case where the crystalline structure is formed with Pt.

On the other hand, FIG. 6A shows that, when the NiAl polycrystalline film 22 is provided on the crystalline structure, FWHM is improved to 4.3° in a case where the lower crystalline structure is formed with Ru (with Ru-TL). Whereas FWHM significantly deteriorates to 6.0° in a case where the crystalline structure is formed with Pt (with Pt-TL) and significantly deteriorates to 8.7° in a case where the crystalline structure is omitted (without TL). Since both platinum (PT) and tantalum (Ta) included in the orientation control layer 13 are amorphous, the entire NiAL film formed on the amorphous material becomes amorphous. This adversely affects the crystal orientation of the first and second Ru underlayers and results in this significant deterioration of FWHM.

In the first embodiment of the present invention, since the uniform formation and random arrangement of the crystalline structures 21a are established by using Ru or Ru alloy material, the crystalline parts 22a deposited on the crystalline structures 21a become the dominant areas of the NiAl polycrystalline film 22. Since NiAl grows on the amorphous Ta orientation control layer 13 at the gap parts between the crystalline structures 21a, the NiAl become amorphous materials 22b at the gap parts. Nevertheless, a large portion of the polycrystalline film 22 is formed by crystalline materials 22a. The polycrystalline film 22 having this configuration improves the crystal orientation of the Ru second underlayer 15. Because the crystalline portions 22a dominating the NiAl polycrystalline film 22 is configured having substantially the same uniform grain size and arrangement as the crystalline structures 21a, inconsistency in the grains size of the crystal grains of the Ru second underlayer 15 can be controlled. The uniform grain size and the satisfactory crystal orientation of the grains of the Ru second underlayer 15 are inherited by the recording layer 16 formed thereon.

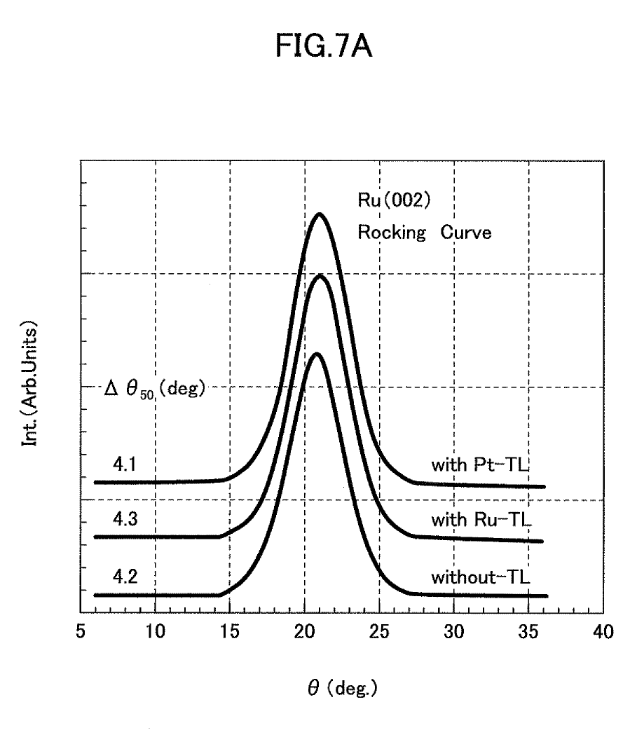

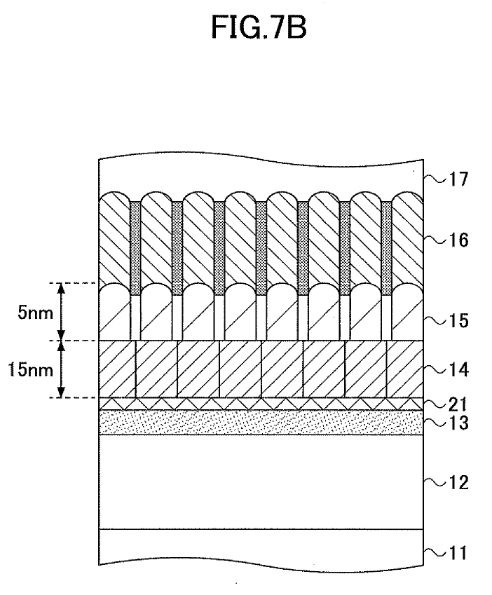

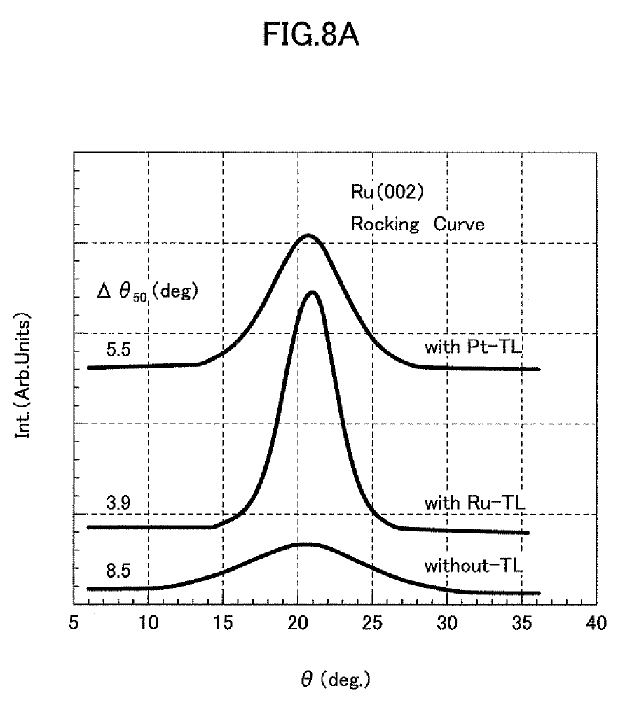

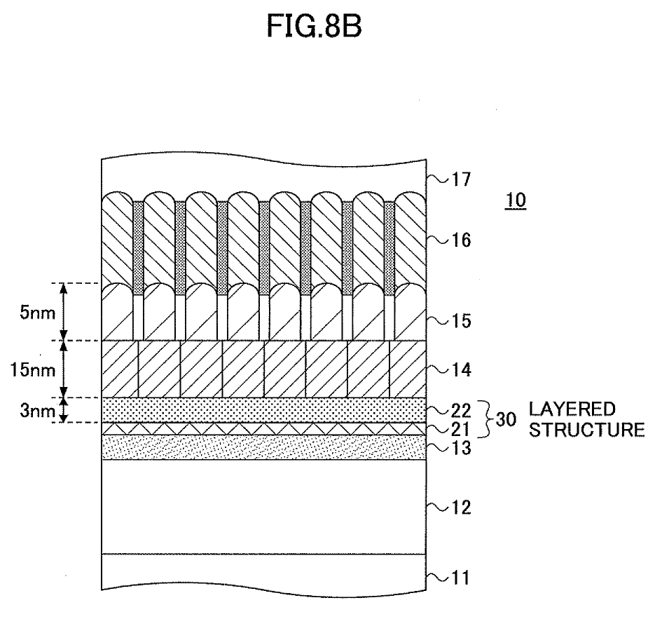

The samples shown in FIGS. 7A-7B and 8A-8B are substantially the same as those of FIGS. 5A-5B and 6A-6B except that the thickness of the Ru first underlayer 14 is changed to 15 nm and the thickness of the Ru second underlayer 15 is changed to 5 nm. Three samples are prepared for measuring the rocking curves in which the first sample has the crystalline structure 21a formed with Ru (indicated as “with Ru-TL” in FIGS. 7A and 8A), a second sample has the crystalline structure formed with Pt (indicated as “with Pt-TL” in FIGS. 7A and 8A), and a third sample has no crystalline structure (indicated as “without-TL” in FIGS. 7A and 8A).

As shown in FIG. 7A, when the NiAl polycrystalline film 22 is not provided, there is little difference between a case where no crystalline structure is provided (FWHM being 4.3°), a case where the crystalline structure is formed with Ru (FWHM being 4.1°), and a case where the crystalline structure is formed with Pt (FWHM being 4.2°).

On the other hand, FIG. 8A shows that, when the NiAl polycrystalline film 22 is provided, FWHM is improved to 3.9° only in the case where the crystalline structure is formed with Ru. Whereas FWHM significantly deteriorates in the case where the crystalline structure is formed with Pt and in the case where the crystalline structure is omitted. The reason for this deterioration is the same as the reason of the deterioration described with the samples of FIGS. 6A and 6B. Furthermore, although it can be understood that crystal orientation can be improved by increasing the thickness of the Ru first underlayer 14, the total thickness of the first and second underlayers 14, 15 is to be determined considering the aspect that the distance between the recording layer 16 and the soft magnetic buffer layer 12 is to be as short as possible and the aspect that the crystal orientation of the Ru second underlayer 15 is to be maintained. In one preferred example, the total thickness of the first and second underlayers 14, 15 is no greater than 20 nm. In this case, since the crystallinity of the Ru second underlayer 14 becomes unsatisfactory when the Ru second underlayer 14 is too thin, it is preferred for the Ru second underlayer 14 to have a thickness ranging from 5 nm through 10 nm.

As a result, by interposing a layered structure 30 including the Ru/Ru alloy crystalline structure 21a (or a template having the granular arrangement of the Ru/Ru alloy crystalline structure 21a) and the polycrystalline film 22 (e.g., formed of NiAl) between the underlayers 14, 15 and the soft magnetic buffer layer 12 below the recording layer 16, both the variance of crystal grain size and the variance of crystal orientation of the crystal grains in the recording layer 16 can be restrained (controlled). More specifically, by interposing the layered structure 30 including the Ru/Ru alloy crystalline structure 21a and the polycrystalline film 22 between the Ru first underlayer 14 and the soft magnetic buffer layer 12 in a case where the first continuous underlayer 14 is used or between the Ru second underlayer 15 and the soft magnetic buffer layer 12 in a case where the first underlayer 14 is not used, both the variance of crystal grain size and the variance of crystal orientation of the crystal grains in the recording layer 16 can be restrained (controlled).

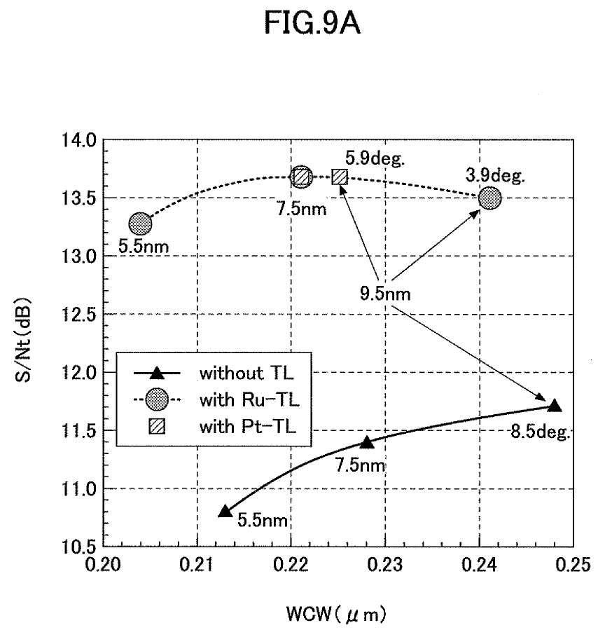

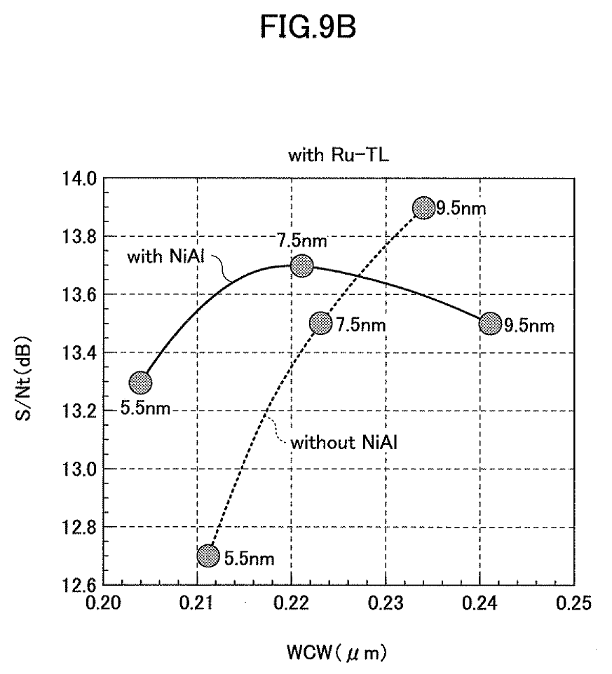

FIG. 9A is a graph showing the dependency of signal to noise ratio (S/Nt) with respect to write core width (WCW) of various samples using the NiAl film 22. FIG. 9B is a graph showing the comparison of the dependency of signal to noise ratio (S/Nt) with respect to write core width (WCW) in a case where the Ru crystalline structure 21a is combined with the NiAl film 22 and a case where no NiAl film 22 is provided. In FIG. 9A, the circles indicate characteristic values (property values) in a case where a Ru crystalline structure 21a is positioned immediately below the NiAl film 22, the squares indicate characteristic values (property values) in a case where a Pt crystalline structure is positioned immediately below the NiAl film 22, and the triangles indicate characteristic values (property values) in a case where no crystalline structure is provided. With respect to the three configurations of FIG. 9A, the thickness of the cap layer 17 is changed (5.5 nm, 7.5 nm, 9.5 nm) along with the changes of WCW.

In the case where no crystalline structure is provided, the FWHM is 8.5° and the signal to noise ratio (S/Nt) is unsatisfactory. The S/Nt characteristic further deteriorates as the WCW becomes narrower. In comparing the case where the Ru crystalline structure 22 is provided and the case where the Pt crystalline structure is provided, the Ru crystalline structure 22 exhibits a narrower WCW for attaining the same S/Nt as that of the Pt crystalline structure. Furthermore, the Ru crystalline structure 22 can achieve a stable S/Nt characteristic regardless of the size of the WCW.

In FIG. 9B, the configuration having the NiAl film 22 provided on the Ru crystalline structure 21a exhibits a low WCW dependency and establishes a stable S/Nt characteristic in the same manner as FIG. 9A. Furthermore, since a uniform S/Nt characteristic can be achieved regardless of the variance of the thickness of the cap layer 17 during manufacturing, the margin can be set larger.

On the other hand, in the configuration where the Ru crystalline structure 21a is provided without the NiAl film 22, the S/Nt characteristic abruptly deteriorates as the WCW becomes narrower. Furthermore, this configuration exhibits a significant varying S/NT characteristic depending on the variance of the thickness of the cap layer 17 during manufacturing.

Hence, by combining the Ru/Ru alloy crystalline structure 21a and the NiAl polycrystalline film 22 as described in the first embodiment of the present invention, both reduction of WCW (achieving higher recording density) and realization of high S/Nt can be achieved.

It is noted that the polycrystalline film 22 layered on the Ru/Ru alloy crystalline structure 21a is not limited to NiAl but may also be a NiAl based alloy.

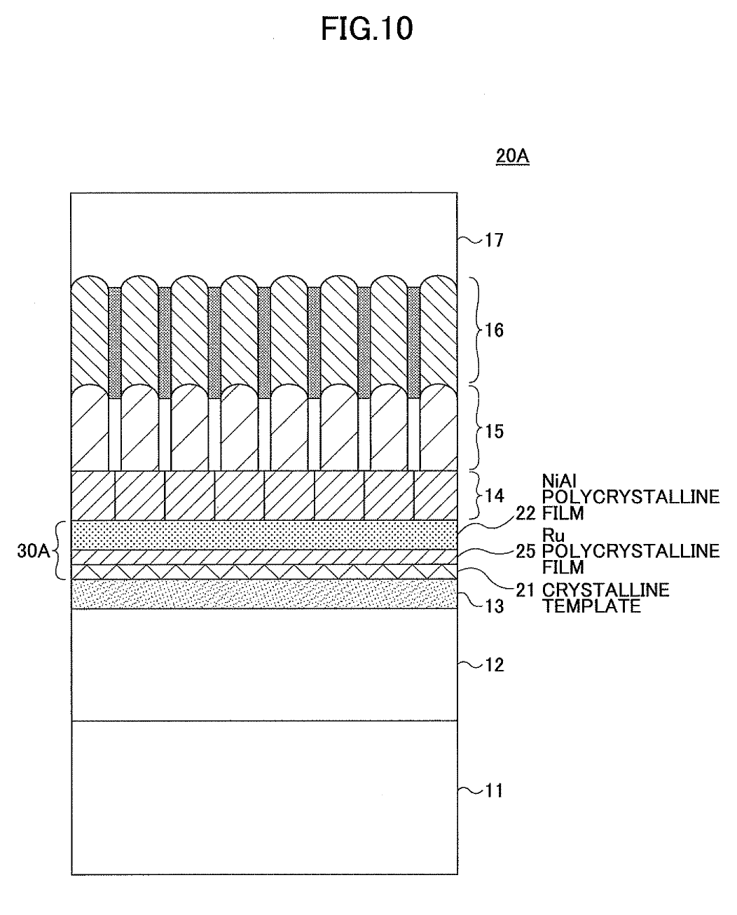

FIG. 10 is a cross-sectional view showing a perpendicular magnetic recording medium 20A according to a second embodiment of the present invention. It is noted that, in the second embodiment of the present invention, like components are denoted by like reference numerals as of the first embodiment and are not further explained.

According to the second embodiment of the present invention, a polycrystalline continuous film 25 formed of Ru or Ru alloy (hereinafter also referred to as “Ru/Ru alloy polycrystalline continuous film 25”) is interposed between the crystalline template 21 formed of Ru or Ru alloy (Ru/Ru alloy crystalline structure 21) and the polycrystalline film 22 formed of NiAl or NiAl based alloy. In the following example describing the second embodiment of the present invention, the polycrystalline film 22 is formed of NiAl and the polycrystalline continuous film 25 is a polycrystalline film formed of Ru. According to the second embodiment of the present invention, a layered structure 30A includes the crystalline template 21, the Ru poly crystalline film 25, and the NiAl polycrystalline film 22 which are layered in this order.

Similar to the first embodiment of the present invention, when NiAl polycrystalline film is directly formed on the crystalline structure template 21 formed on the Ta orientation control film 13, the NiAl that grows on the Ru/Ru alloy crystalline structure 21a becomes polycrystalline material 22a whereas the NiAl that grows on amorphous Ta orientation control film 13 becomes amorphous material 22b (see FIG. 3). In this case, there is a possibility that deterioration of crystal orientation could occur in a portion of the first under layer (Ru continuous film) 14 that grows on the amorphous material 22b of the NiAl polycrystalline film 22.

Therefore, in the second embodiment of the present invention, by interposing the Ru polycrystalline film 25 (second polycrystalline film) in a continuous state between the NiAl polycrystalline film 22 and the Ru crystalline structure template 21, the first underlayer 14, which is to be the underlayer of the magnetic recording layer 16, can attain a crystal orientation with little variance.

In this case, the Ru crystalline structure template 21 having a thickness of 1.5 nm is formed on the Ta orientation control film 13 by performing DC sputtering deposition at room temperature using Ar gas with a pressure of 8 Pa. In this example, the deposition rate is 0.5 nm/sec. Then, The Ru polycrystalline film 25 is formed (grown) to a thickness of 3 nm by performing DC sputtering deposition using Ar gas with a pressure of 0.5 Pa. In this example, the deposition rate is 3.0 nm/sec. Then, the NiAL polycrystalline film 22 having a thickness of 3 nm is formed as a continuous film by performing DC sputtering method at room temperature by using Ar gas with a pressure of 0.5 Pa. In this example, the deposition rate is 2.5 nm/sec. The subsequent steps (processes) are the same as the corresponding steps (processes) described in the first embodiment of the present invention.

With this configuration, since the NiAl polycrystalline film 22 does not grow directly on the amorphous Ta orientation control film 13, the entire NiAl polycrystalline film 22 uniformly becomes a polycrystalline state. Thus, the Ru first underlayer 14 that grows on the continuous film attains a uniform crystal orientation.

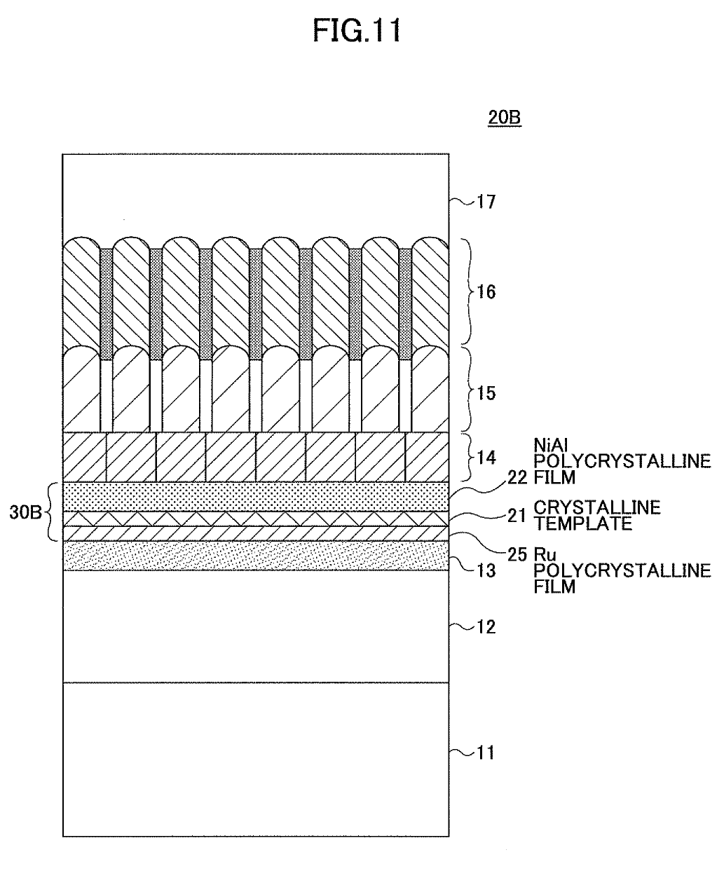

FIG. 11 is a cross-sectional diagram showing a perpendicular magnetic recording medium 20B according to a third embodiment of the present invention. It is noted that, in the third embodiment of the present invention, like components are denoted by like reference numerals as of the first and second embodiments of the present invention and are not further explained. In the third embodiment of the present invention, a Ru polycrystalline film 25 is provided as the underlayer of the Ru/Ru alloy crystalline structure template 21. In this case, a layered structure 30B includes the Ru polycrystalline film 25, the crystalline template 21, and the NiAl polycrystalline film 22 which are layered in this order. This configuration also enables the NiAl polycrystalline film 22 to uniformly become a polycrystalline film since the NiAL polycrystalline film 22 does not grow directly on the amorphous Ta orientation control film 13.

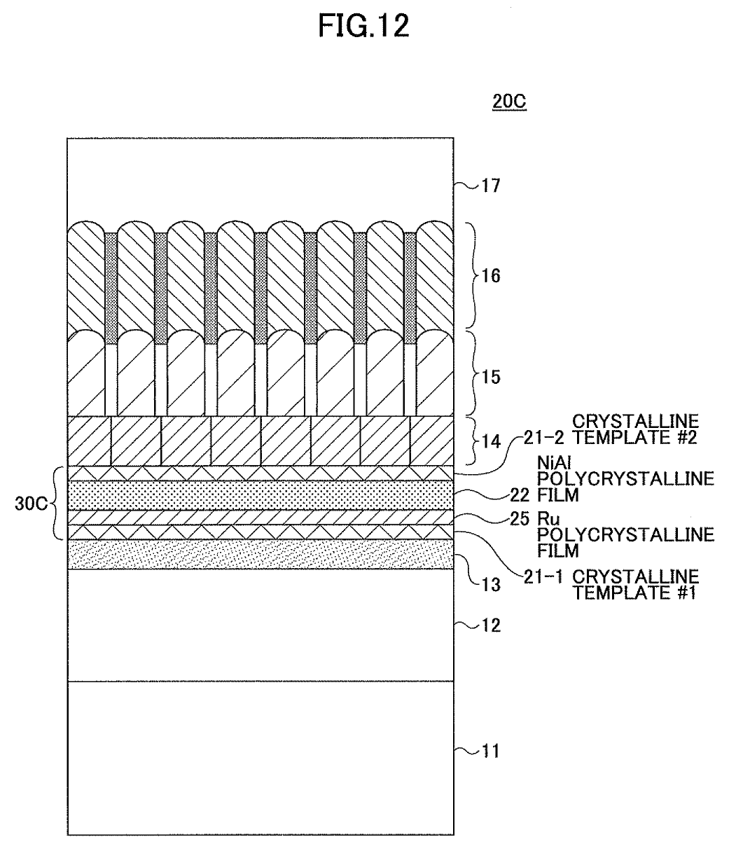

FIGS. 12, 13 and 14 show a perpendicular magnetic recording medium 20C, 20D, 20E according to the fourth, fifth, and sixth embodiments of the present invention. In these embodiments, the Ru crystalline structure template 21 is provided on the NiAl polycrystalline film 22. The configuration where the NiAl polycrystalline film 22 does not directly grow on the amorphous Ta orientation control film 13 is the same as the configuration described in the second and third embodiments of the present invention. It is noted that, in the following fourth, fifth, sixth embodiments of the present invention, like components are denoted by like reference numerals as of the first, second, and third embodiments of the present invention and are not further explained.

As shown in FIG. 12, in the fourth embodiment of the present invention, a layered structure 30C formed on the Ta orientation control film 13 includes a first Ru crystalline structure template 21-1 (film thickness: 1.5 nm), The Ru polycrystalline film 25 (film thickness: 3 nm), the NiAl polycrystalline film 22 (film thickness: 3 nm), and a second Ru crystalline structure template 21-2 (film thickness: 1.5 nm) which are layered in this order. This configuration has the second Ru crystalline structure template 21-2 provided on the NiAl polycrystalline film 22 of the layered structure 30B described in the second embodiment of the present invention. By providing the second Ru crystalline structure template 21-1 immediately below the first underlayer 14, variance of crystal orientation can be improved.

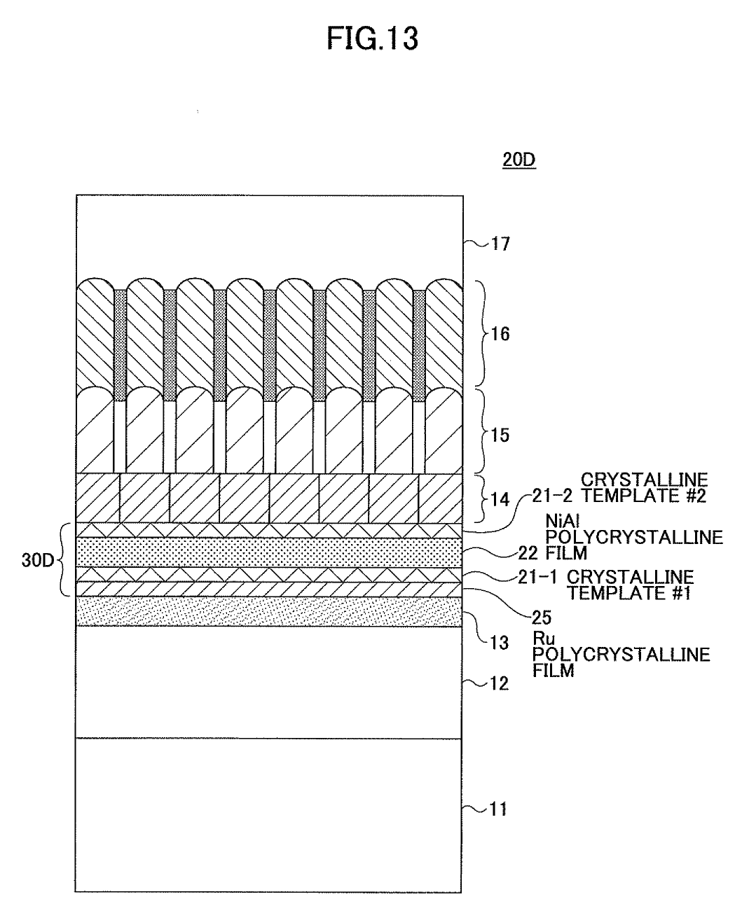

As shown in FIG. 13, in the fifth embodiment of the present invention, a layered structure 30D formed on the Ta orientation control film 13 includes the Ru polycrystalline film 25 (film thickness: 3 nm), the first Ru crystalline structure template 21-1 (film thickness: 1.5 nm), the NiAl polycrystalline film (film thickness: 3 nm), and the second Ru crystalline structure template 21-2 (film thickness: 1.5 nm) which are layered in this order. This configuration has the second Ru crystalline structure template 21-2 provided on the NiAl polycrystalline film 22 of the layered structure 30B described in the third embodiment of the present invention. Same as the fourth embodiment of the present invention, by providing the second Ru crystalline structure template 21-2 immediately below the first underlayer 14, variance of crystal orientation can be improved.

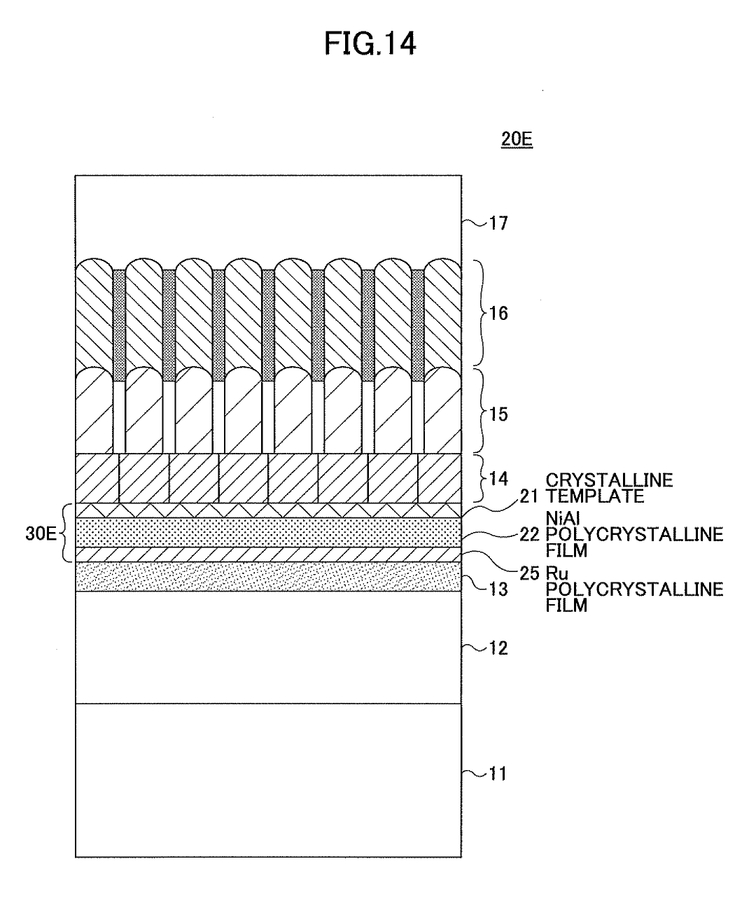

As shown in FIG. 14, in the sixth embodiment of the present invention, a layered structure 30E formed on the Ta orientation control film 13 includes the Ru polycrystalline film 25 (film thickness: 3 nm), the NiAl polycrystalline film 22 (film thickness: 3 nm), and the Ru crystalline structure template 21 (film thickness: 1.5) which are layered in this order. This configuration switches the layered order of the Ru crystalline structure template 21 and the NiAl polycrystalline film 22 of the layered structure 30B described in the third embodiment of the present invention. Same as the fourth and fifth embodiments of the present invention, by providing the second Ru crystalline structure template 21 immediately below the first underlayer 14, variance of crystal orientation in the magnetic recording layer 16 can be improved.

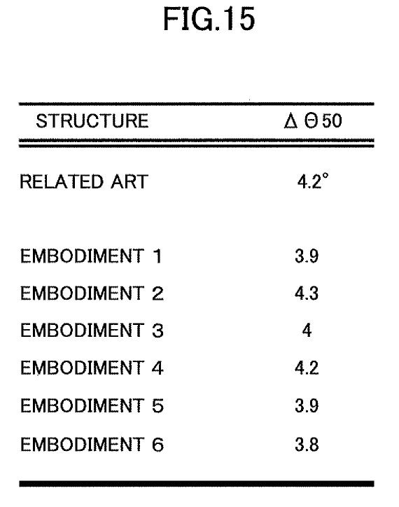

FIG. 15 is a table showing the crystal orientation (Δθ₅₀) of the magnetic recording layer 16 of the perpendicular magnetic recording media of the first through sixth embodiments of the present invention. For comparison, the table also shows the crystal orientation (Δθ₅₀) of the perpendicular magnetic recording medium according to the related art example shown in FIG. 1. Same as the samples used in FIGS. 8A and 8B, the table shows the crystal orientation (Δθ₅₀) in a case where the magnetic recording media of the first through sixth embodiments and the related art example shown are formed with the Ru first underlayer 14 having a thickness of 15 nm and corresponding XRD rocking curves with respect to the Ru (002) are measured.

The table of FIG. 15 shows that crystal orientation becomes better in a case where the Ru polycrystalline film 25 is provided below the Ru crystalline structure template 21 (embodiments 3, 5, and 6) than a case where the Ru polycrystalline film 25 is interposed between the NiAl polycrystalline film 22 and the Ru crystalline structure template 21 (embodiments 2 and 4). Furthermore, as shown in the fifth embodiment of the present invention, crystal orientation improves when the two or more layers of the Ru crystalline structure template 21-1 and 21-2 are used.

As shown in the sixth embodiment of the present invention, it may seem that providing a single layer of the Ru polycrystalline structure template 21 immediately below the Ru first underlayer 14 is advantageous when focusing only on the variance of the crystal orientation (Δθ₅₀). However, as shown in the fourth and fifth embodiments of the present invention, it is more advantageous when two or more layers of the Ru crystalline structure template 21 are used when considering read/write characteristics (described below). It is, however, to be noted that the magnetic force required for performing a writing process increases if the space between the soft magnetic buffer layer 12 and the magnetic recording layer 16 become too large. Therefore, it is preferable to determine the number of layers of the template by considering the overall structure of the perpendicular magnetic recording medium.

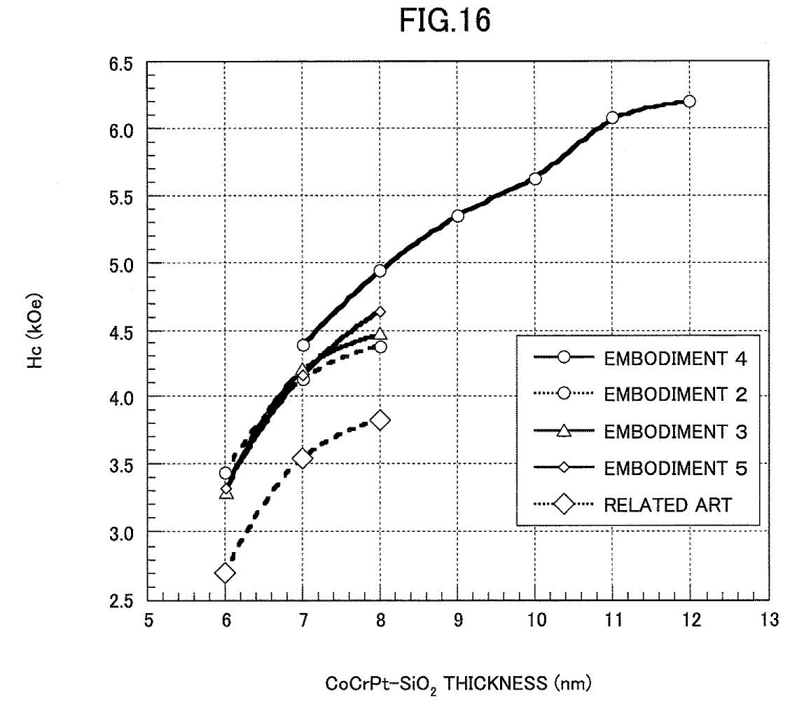

FIG. 16 a graph showing the coercivity (Hc) of the perpendicular magnetic recording media of the first through sixth embodiments of the present invention together along with the coercivity (Hc) of the perpendicular magnetic recording medium according to the related art example shown in FIG. 1. The coercivity shown in the graph of FIG. 16 is expressed as a function with respect to the thickness of the magnetic recording layer (CoCrPt—SiO₂) having a granular structure. In the graph of FIG. 16, the dotted line and the white circles illustrated on the dotted line represent the characteristics of the second embodiment of the present invention, the solid line and the triangles illustrated on the solid line represent the characteristics of the third embodiment of the present invention, the solid line and the black circles illustrated on the solid line represent the characteristics of the fourth embodiment of the present invention, the solid line and the small rhombus illustrated on the solid line represent the characteristics of the fifth embodiment of the present invention, and the dotted line and the large rhombus illustrated on the dotted line represent the characteristics of the related art example.

The embodiments of the present invention shown in the graph of FIG. 16 show that coercivity is improved compared to that of the related art example. In a case where the film thickness of the magnetic recoding layer 16 is greater than 7 nm, a configuration provided with plural layers of the Ru crystalline structure templates 21-1, 21-2 (fourth and fifth embodiments of the present invention) exhibit a better coercivity than that of the configurations of the second and third embodiments of the present invention. It is, however, to be noted that signal to noise (S/Nt) ratio deteriorates when the thickness of the magnetic recording layer 16 is too large. Therefore, it is preferable to determine the suitable thickness of the magnetic recording layer suitable for the configuration of the fourth and fifth embodiments of the present invention (described below).

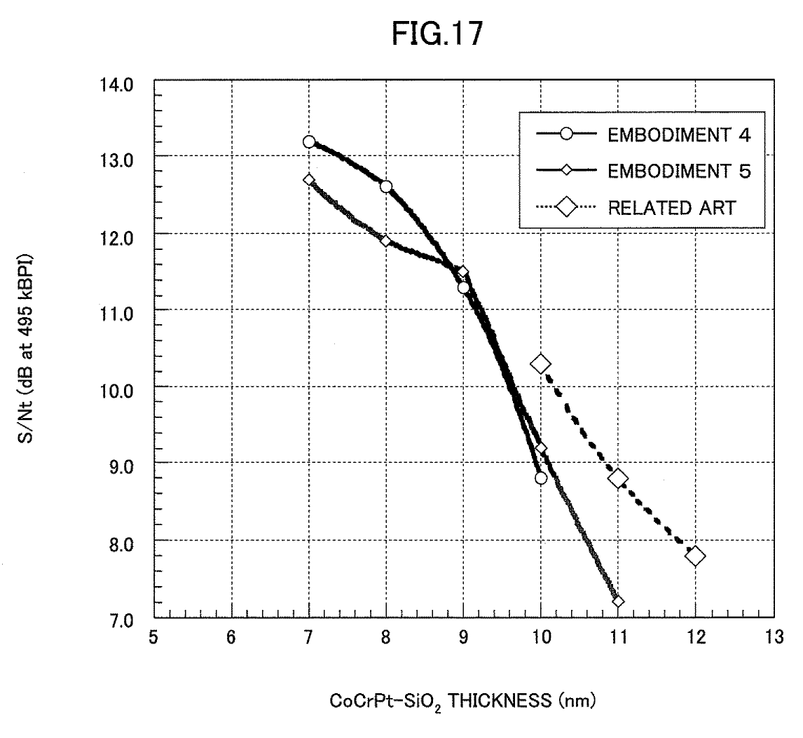

FIG. 17 is a graph showing the signal to noise (S/Nt) ratio of the perpendicular magnetic recording media of the fourth and fifth embodiments of the present invention. The signal to noise ratio shown in the graph of FIG. 17 is expressed as a function with respect to the thickness of the magnetic recording layer (CoCrPt—SiO₂) 16 having a granular structure. As a comparative example, the graph of FIG. 17 also shows the signal to noise ratio of the perpendicular magnetic recording medium according to the related art example shown in FIG. 1. The graph of FIG. 17 shows that the preferable film thickness of the magnetic recording layer 16 ranges from 7 through 10 nm, and more preferably from 7 through 9 nm.

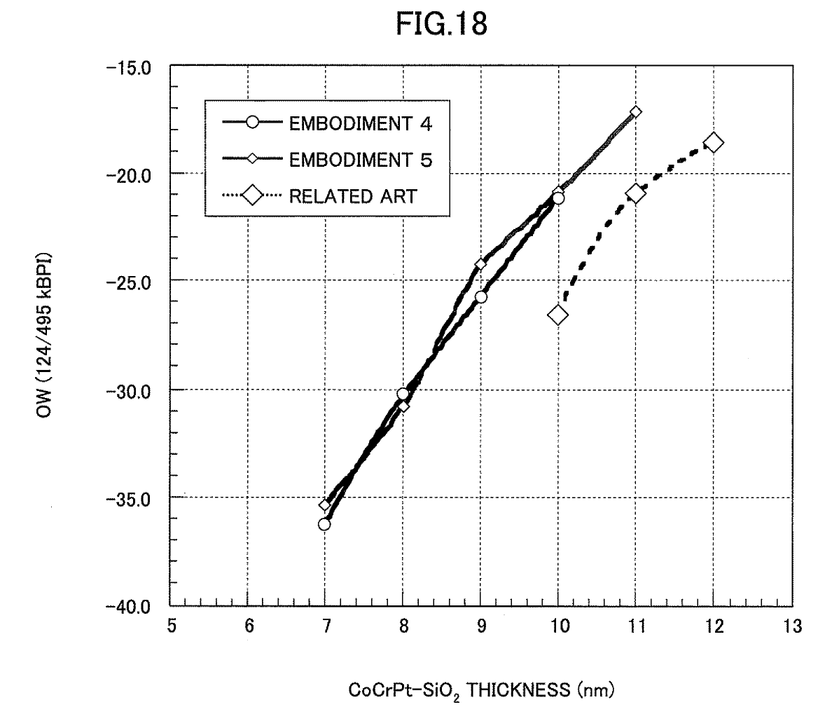

FIG. 18 is a graph showing the overwrite characteristics of the perpendicular magnetic recording media of the fourth and fifth embodiments of the present invention. The overwrite characteristics shown in the graph of FIG. 18 is expressed as a function with respect to the thickness of the magnetic recording layer (CoCrPt—SiO₂) 16 having a granular structure. As a comparative example, the graph of FIG. 18 also shows the overwrite characteristics of the perpendicular magnetic recording medium according to the related art example shown in FIG. 1. The graph of FIG. 18 shows that the preferable film thickness of the magnetic recording layer 16 is 7 nm or more, and more preferably 9 nm or more for attaining satisfactory overwrite characteristics.

In view of the results shown in FIGS. 15 through 18, the configuration of the fifth embodiment of the present invention is significantly satisfactory. In a case where the configuration of the fifth embodiment of the present invention is used, the preferred film thickness of the magnetic recording layer ranges from 7 through 10 nm (more preferably, 8 through 9 nm). It is, however, to be noted that a sufficient coercivity can be attained by using the configurations of the remaining embodiments of the present invention. Particularly, in a case where the configuration of the fourth embodiment of the present invention is used, a satisfactory coercivity, signal to noise ratio, and overwrite characteristics can be attained even though the crystal orientation of the configuration of the fifth embodiment of the present invention is slightly better than that of the fourth embodiment of the present invention.

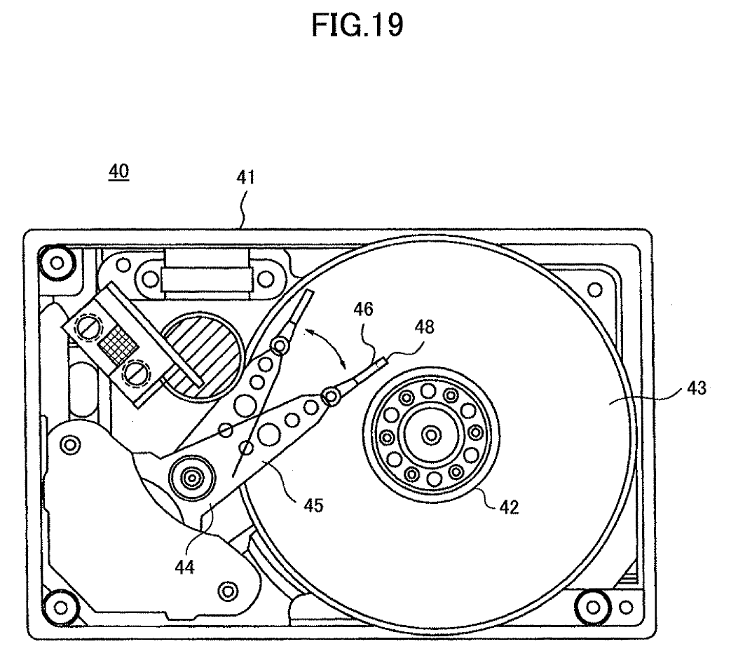

FIG. 19 is a schematic diagram showing a magnetic recording apparatus 40 (e.g., hard disk drive) applicable to any one of the above-described perpendicular magnetic recording media 10, 20A-20E of the first through sixth embodiments of the present invention. The magnetic recording apparatus 40 according to an embodiment of the present invention has a housing 41. The housing 41 contains, for example, a hub 42 driven by a spindle (not shown), a magnetic recording medium 43 fixed to the hub 42 and rotated by the spindle, an actuator unit 44, an arm 45 supported by the actuator unit 44 and driven in the radial direction of the magnetic recording medium 43, a suspension 46, and a magnetic head(s) 48 supported by the suspension 46. The magnetic recording medium 43 is configured having one or more layers of the above-described perpendicular magnetic recording medium 10 (or any one of 20A, 20B, 20C, 20D, and 20E). The magnetic head(s) 48 corresponding to each perpendicular magnetic recording medium 10 (20A-20E) is provided in the magnetic recording apparatus 40. The magnetic recording apparatus 40 has a magnetic recording/reproducing part for recording data to the magnetic recording medium 43 and reproducing data recorded in the magnetic recording medium 43. It is to be noted that the magnetic recording/reproducing part includes the magnetic head 48. Accordingly, with respect to each perpendicular magnetic recording medium 10 (20A-20E), the magnetic recording apparatus 40 can achieve a high S/Nt and attain a narrow write core width (WCW). That is, high performance and high recording density can be achieved with the magnetic recording apparatus 40.

Further, the present invention is not limited to these embodiments, but variations and modifications may be made without departing from the scope of the present invention.

The present application is based on Japanese Priority Application Nos. 2007-138010 and 2007-267654 filed on May 24, 2007 and Oct. 15, 2007 with the Japanese Patent Office, the entire contents of which are hereby incorporated by reference.

What is claimed is:

1. A perpendicular magnetic recording medium comprising:
a substrate;
a soft magnetic buffer layer formed on the substrate;
a Ru/Ru alloy underlayer formed on the soft magnetic buffer layer, the Ru/Ru alloy underlayer including Ru or a Ru alloy;
a recording layer formed on the Ru/Ru alloy underlayer, the recording layer including at least a layer including
a plurality of magnetic particles having an easy axis oriented perpendicular to the substrate, and
a non-magnetic material surrounding the plural magnetic particles; and
a layered structure interposed between the soft magnetic buffer layer and the Ru/Ru alloy underlayer, the layered structure including at least
a Ru/Ru alloy crystalline structure film including Ru or a Ru alloy,
a first polycrystalline film including Ru or a Ru alloy, and
a second polycrystalline film.

2. The perpendicular magnetic recording medium as claimed in claim 1, wherein the second polycrystalline film includes a NiAl alloy polycrystalline film or a NiAl based polycrystalline film having a single element material added to a NiAl alloy.

3. The perpendicular magnetic recording medium as claimed in claim 2, wherein the NiAl based polycrystalline film is positioned directly above the first polycrystalline film, wherein the first polycrystalline film is positioned directly below the Ru/Ru alloy crystalline structure film.

4. The perpendicular magnetic recording medium as claimed in claim 2, wherein the NiAl based polycrystalline film is positioned directly above the Ru/Ru alloy crystalline structure film, wherein the first polycrystalline film is positioned directly below the Ru/Ru alloy crystalline structure film.

5. The perpendicular magnetic recording medium as claimed in claim 3, wherein the layered structure further includes another Ru/Ru alloy crystalline structure film including Ru or a Ru alloy, wherein the other Ru/Ru alloy crystalline structure film is positioned directly above the second polycrystalline film.

6. A perpendicular magnetic recording medium comprising:
a substrate;
a soft magnetic buffer layer formed on the substrate;
a Ru/Ru alloy underlayer formed on the soft magnetic buffer layer, the Ru/Ru alloy underlayer including Ru or a Ru alloy;
a recording layer formed on the Ru/Ru alloy underlayer, the recording layer including at least a layer including
a plurality of magnetic particles having an easy axis oriented perpendicular to the substrate, and
a non-magnetic material surrounding the plural magnetic particles; and
a layered structure interposed between the soft magnetic buffer layer and the Ru/Ru alloy underlayer, the layered structure including at least
a first Ru/Ru alloy crystalline structure film including Ru or a Ru alloy,
a NiAl based polycrystalline film positioned directly above the first Ru/Ru alloy crystalline structure film, and
a second Ru/Ru alloy crystalline structure film including Ru or a Ru alloy.

7. The perpendicular magnetic recording medium as claimed in claim 1, wherein the Ru alloy is an alloy having Ru as a main component, wherein when the Ru alloy is expressed as “Ru—X”, “X” includes at least one of Co, Cr, Fe, Ni, W, and Mn.

8. The perpendicular magnetic recording medium as claimed in claim 2, wherein the single element material includes at least one of B, Pt, W, Ag, Au, Pd, Nb, Ta, Cr, Si, and Ge.

9. The perpendicular magnetic recording medium as claimed in claim 1, wherein the Ru/Ru alloy crystalline structure film includes a crystalline structure having a height ranging from 1 nm through 2 nm.

10. The perpendicular magnetic recording medium as claimed in claim 1, wherein the Ru/Ru alloy crystalline structure film includes a crystalline structure having a grain size no greater than 2 nm.

11. The perpendicular magnetic recording medium as claimed in claim 2, wherein the second polycrystalline film has a thickness ranging from 2 nm through 4 nm.

12. A magnetic recording apparatus comprising:
a recording/reproducing part including a recording head; and
the perpendicular recording medium as claimed in claim 1.

13. A method of manufacturing a perpendicular magnetic recording medium comprising the steps of:
a) forming a layered structure including at least a Ru/Ru alloy crystalline structure film including Ru or a Ru alloy on a substrate, a first polycrystalline film including Ru or a Ru alloy, and a second polycrystalline film;
b) forming an Ru/Ru alloy underlayer formed on the layered structure, the Ru/Ru alloy underlayer including crystal grains of Ru or Ru alloy that are spatially separated from each other by gap parts formed in the Ru/Ru alloy underlayer; and
c) forming a recording layer on the Ru/Ru alloy underlayer, the recording layer including at least a layer including a plurality of magnetic particles having an easy axis oriented perpendicular to the substrate and a non-magnetic material surrounding the plural magnetic particles.

14. A method of manufacturing a perpendicular magnetic recording medium comprising the steps of:
a) forming a layered structure including at least a first Ru/Ru alloy crystalline structure film including Ru or a Ru alloy, a NiAl based polycrystalline film positioned directly above the first Ru/Ru alloy crystalline structure film, and a second Ru/Ru alloy crystalline structure film including Ru or a Ru alloy;
b) forming a Ru/Ru alloy underlayer formed on the layered structure, the Ru/Ru alloy underlayer including crystal grains of Ru or Ru alloy that are spatially separated from each other by gap parts formed in the Ru/Ru alloy underlayer; and
c) forming a recording layer on the Ru/Ru alloy underlayer, the recording layer including at least a layer including a plurality of magnetic particles having an easy axis oriented perpendicular to the substrate and a non-magnetic material surrounding the plural magnetic particles.

15. The method of manufacturing a perpendicular magnetic recording medium as claimed in claim 13, wherein the Ru/Ru alloy crystalline structure film has a crystalline structure formed by sputtering a Ru or a Ru alloy target with an argon gas pressure ranging from 7 Pa to 8.5 Pa. at a deposition rate no greater than 0.5 nm/sec.

16. The method of manufacturing a perpendicular magnetic recording medium as claimed in claim 13, wherein the second polycrystalline film is formed as a NiAl alloy polycrystalline film or a NiAl based polycrystalline film having a single element material added to a NiAl alloy.
